(19) United States
(12) Patent Application Publication
(10) Pub. No.: US 2007/0260498 A1
(43) Pub. Date: Nov. 8, 2007

(54) Business justification analysis system

(76) Inventors: Takeshi Yokota, Hitachi (JP); Kaoru Kawabata, Hitachi (JP); Tsuyoshi Niino, Tokyo (JP); Takahide Kawasaki, Tokai (JP); Naoki Akane, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/581,345

(22) Filed: Oct. 17, 2006

(30) Foreign Application Priority Data
Oct. 18, 2005 (JP) 2005-302427

(51) Int. Cl. G06Q 10/00

(52) U.S. Cl. 705/7

(57) ABSTRACT

A business justification analysis system for accurately analyzing an opportunity of a business and a risk thereof with a low load. The system basically includes six components, that is, a database for storing a correspondence between opportunity classification items and risk check items, a database for storing the risk check items, a device for selecting the opportunity classification items, a device for extracting the risk check items, a device for inputting a risk check list, and a database for storing risk scores. Information for defining the correspondence between the opportunity classification items of the business and the risk check list items thereof has information about the magnitude of the correspondence. The system further includes a device for applying different weights to the respective check items according to the information when scores of the risk check items are summed.

### BACKGROUND OF THE INVENTION

The present invention relates to a business justification analysis system and a business justification analysis program for previously analyzing the opportunity and risk of a business.

When it is desired to previously determine the necessity or non-necessity of execution of a business, there has been conventionally employed, in many cases, a method for previously analyzing the opportunity and risk of the business and determining the necessity or non-necessity on the basis of the analyzed result. In this connection, the analysis has been made, in many cases, mainly based on the business profit or return.

Typical one of such conventional techniques as mentioned above is disclosed, for example, in JP-A-2004-302705, entitled “Investment Evaluation System”.

### SUMMARY OF THE INVENTION

In JP-A-2004-302705, a profit availability usually accompanied by a risk is analyzed. Meanwhile, recent movement is directed to properly analyze even the opportunities (employee education, customer relation enhancement or reinforcement, etc.) other than the profit, and correspondingly it has been demanded to analyze a range broadened even to the opportunities other than the profit.

However, as the number of opportunity indexes increases, the number of risk items affected by the realization of the opportunity indexes is largely increased. Thus when the number of evaluation items is merely increased in the prior art technique, this leads to the fact that the working load imposed on an analyzing person or analyzer is increased, disadvantageously resulting in that the evaluating technique becomes impractical.

In order to solve the above problem, the present invention is arranged so that a correlation between opportunity classification items and risk check items, increased by including items other than the profit, is previously defined to prompt a user to select the opportunity classification items in an analysis target business. As a result, the number of risk check items is decreased by using the relation definition information to extract the risk check items associated with the selected opportunity classification items.

In the present invention, the risk check items associated with the opportunities of a business to be analyzed of an analysis target business can be narrowed down. As a result, user's load of inputting a risk check list can advantageously be lightened while the accuracy of an evaluation result is maintained.

### BRIEF DESCRIPTION OF THE DRAWINGS

FIG. 1 shows a basic arrangement of a business justification analysis system;

FIG. 2 is an arrangement of the business justification analysis system;

FIG. 3 shows a flow of processing operations of the business justification analysis system;

FIG. 4 is an example of a data recording format of opportunity check item data;

FIG. 5 is an example of a display screen of an opportunity check list input device;

FIG. 6 is an example of the display screen of displaying choices of the opportunity check list input device;

FIG. 7 is an example of the display screen of displaying an opportunity score of the opportunity check list input device;

FIG. 8 shows a flow of operations of calculating the opportunity score of the opportunity check list input device;

FIG. 9 is an example of the data recording format of data on a correspondence between opportunity classification items and opportunity check items;

FIG. 10 is a flow of operations of an opportunity score collecting device;

FIG. 11 is an example of the data recording format of opportunity classification item score data;

FIG. 12 is an example of a display screen of an opportunity classification item selecting device;

FIG. 13 is an example of the display screen of displaying a warning in the opportunity classification item selecting device;

FIG. 14 is an example of the data recording format of risk check item data;

FIG. 15 is an example of the data recording format of data on a correspondence between the opportunity classification items and the risk check items;

FIG. 16 is a flow of operations of a risk check item extracting device;

FIG. 17 is an example of a display screen of a risk check list input device;

FIG. 18 is an example of displaying a highlighted risk check item of the risk check list input device;

FIG. 19 is a flow of operations of calculating a risk score of the risk check list input device;

FIG. 20 is a flow of operations of collecting the risk scores of the risk check list input device;

FIG. 21 is an example of the data recording format of risk score data; and

FIG. 22 is an example of an arrangement of hardware.

### DETAILED DESCRIPTION OF THE EMBODIMENTS

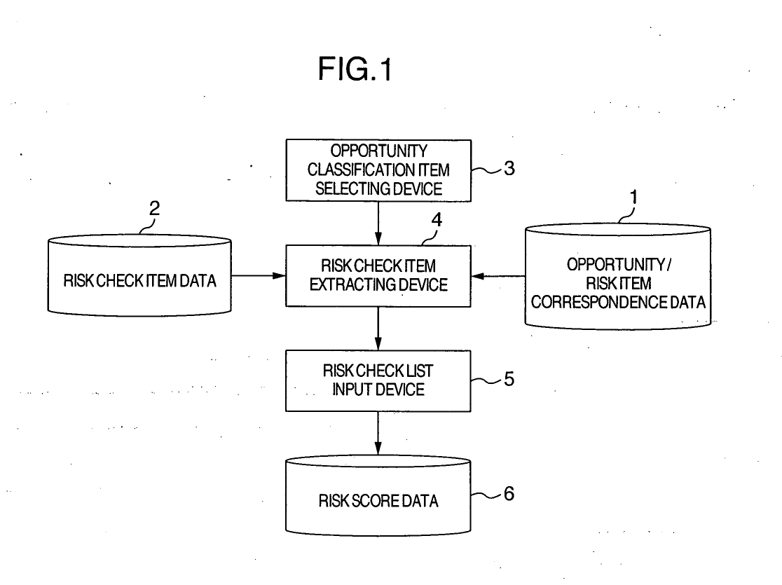

An embodiment of the present invention will be explained in detail with reference to FIGS. 1 to 22.

FIG. 1 shows a basic arrangement of a system in accordance with the present invention. The system is basically made up of six components. That is, the system includes database (1) about a correspondence between opportunity classification items and risk check items (which will be abbreviated to opportunity/risk item correspondence data or database (1), hereinafter), risk check item database (2), an opportunity classification item selecting device (3), a risk check item extracting device (4), a risk check list input device (5), and risk score database (6).

When the risk of an ordered business is analyzed, a user first selects opportunity classification items expected to be acquired by executing the business with use of the opportunity classification item selecting device (3). Next, the risk check item extracting device (4) extracts risk check items associated with the opportunity classification items selected by the user from the risk check item database (2) using information on the opportunity/risk item correspondence data (1), and forms a risk check list corresponding to the analysis target business. And the risk check list input device (5) displays the check list formed by the risk check item extracting device (4) to prompt the user to enter an input operation. The risk check list input device calculates a risk score according to the entered contents and outputs the calculated result as the risk score data (6).

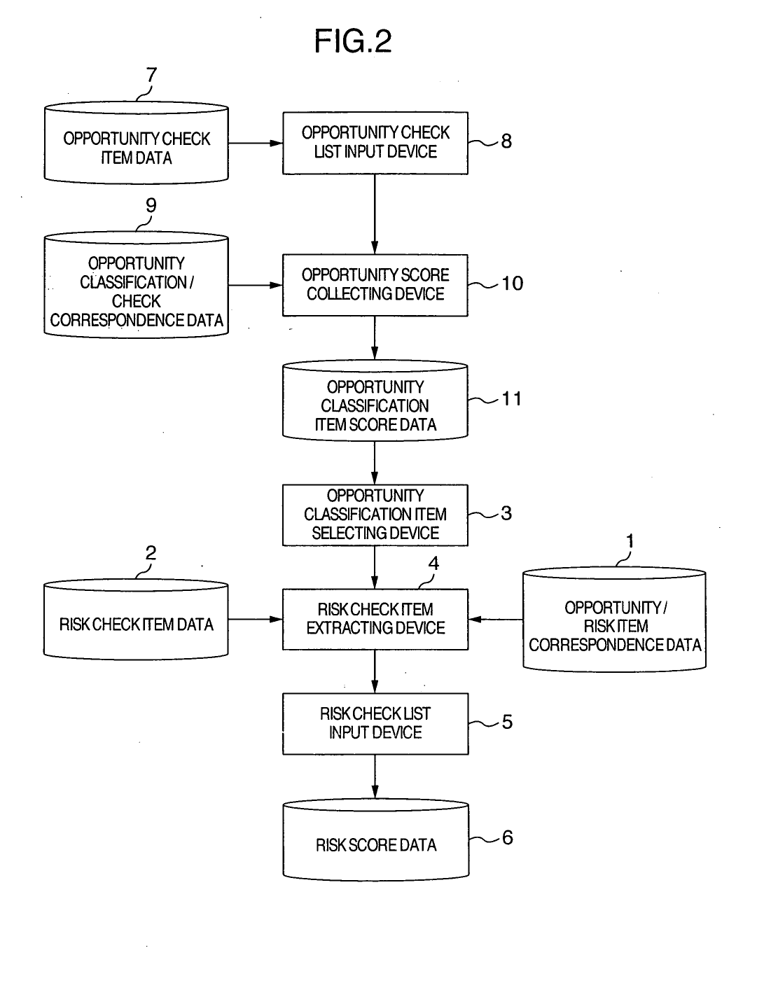

FIG. 2 shows a basic arrangement of a system obtained when the function expansion is applied to the system of FIG. 1. The system of FIG. 2 is basically made up of eleven components. That is, the system includes the opportunity/risk item correspondence database (1), the risk check item database (2), the opportunity classification item selecting device (3), the risk check item extracting device (4), the risk check list input device (5), the risk score database (6), opportunity check item database (7), an opportunity check list input device (8), database (9) about a relation between opportunity classification items and opportunity check items (which will be abbreviated to opportunity classification/check correspondence data or database (9), hereinafter), an opportunity score collecting device (10), and opportunity classification item score database (11).

When an ordered business is evaluated, the opportunity check list input device (8) displays an opportunity check list formed based on the opportunity check item data (7) to prompt the user to enter an input operation. And the opportunity check list input device calculates an opportunity score for each opportunity check item according to the entered contents. Next, the opportunity score collecting device (10) collects the score of each opportunity check item calculated by the opportunity check list input device (8) in units of the opportunity classification item with use of information on the opportunity classification/check correspondence data (9), and outputs the collected scores as the opportunity classification item score data (11). The opportunity classification item selecting device (3) displays the opportunity score for each opportunity classification item to prompt the user to select the opportunity classification item expected to be acquired by executing the ordered business while considering the displayed information. The risk check item extracting device (4) then extracts the risk check items associated with the opportunity classification item selected by the user from the risk check item database (2) with use of information about the opportunity/risk item correspondence data (1), and forms a risk check list corresponding to the analysis target business. The risk check list input device (5) displays the check list formed by the risk check item extracting device (4) to prompt the user to enter an input operation. The risk check list input device calculates a risk score according to the entered contents and outputs the calculated score as the risk score data (6).

Detailed explanation will then be made as to the system of FIG. 2 in this embodiment.

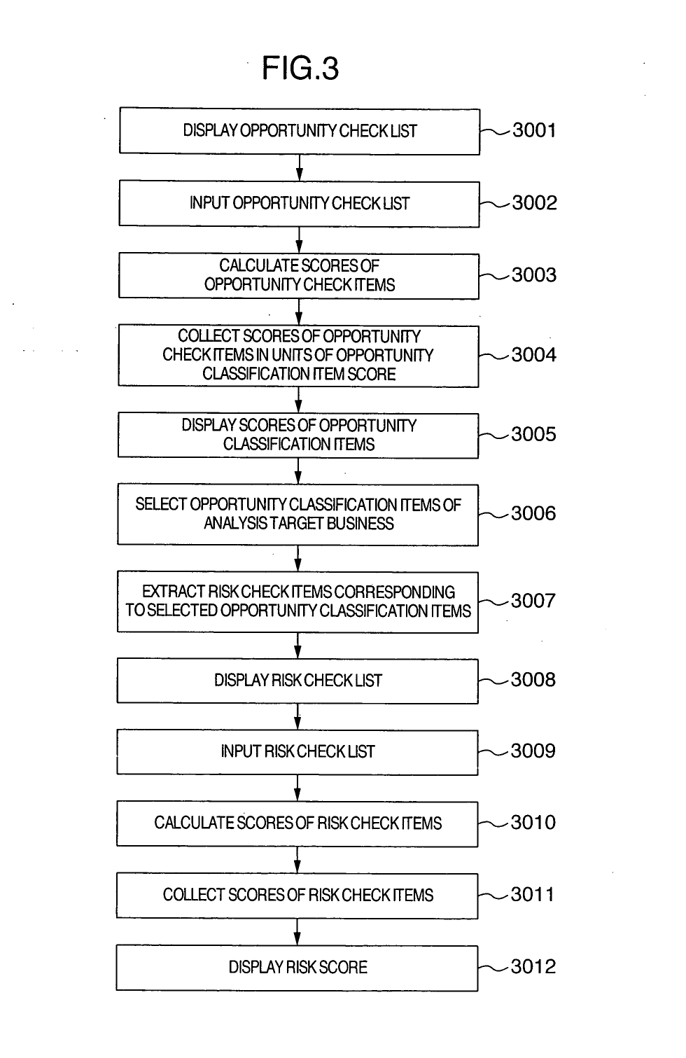

FIG. 3 shows a follow chart of entire operations of the system. In a processing step (3001), the system displays a check list for analysis of an opportunity on the basis of information on the opportunity check item data (7). In a processing step (3002), the user enters an input operation for each opportunity check item in the opportunity check list displayed in the processing step (3001). In a processing step (3003), the system calculates an opportunity score for each opportunity check item according to the result entered by the user with use of an opportunity scoring rule defined in the opportunity check item data (7). In a processing step (3004), the system judges a correspondence between the opportunity check items and the opportunity classification items with use of information on the opportunity classification/check correspondence data (9), collects opportunity scores for a group of opportunity check items associated therewith in units of the opportunity classification item, and outputs the collected result as the opportunity classification item score data (11). In a processing step (3005), on the basis of information on the opportunity classification item score data (11), the system displays a total value of the collected opportunity scores for each opportunity classification item. In a processing step (3006), the system prompts the user to select opportunity classification items expected to be acquired by executing the analysis target business while referring to information displayed in the processing step (3005). In a processing step (3007), the system extracts risk check items to be considered in order to realize the opportunity classification item selected in the processing step (3006) from the risk check item data (2) with use of information on the opportunity/risk item correspondence data (1). In a processing step (3008), the system displays a risk check list for the analysis target business by displaying the risk check items extracted in the processing step (3007). In a processing step (3009), the user enters an input operation for each risk check item in the risk check list displayed in the processing step (3008). In a processing step (3010), the system calculates a risk score for each risk check item according to the result entered by the user with use of a risk score ring rule defined in the risk check item data (2). In a processing step (3011), the system collects a score for each risk check item in the check list, and outputs the collected scores as the risk score data (6). In a processing step (3012), the system displays the risk score.

The system (of FIG. 2) in accordance with an embodiment of present invention will be explained more in detail with use of a specific example.

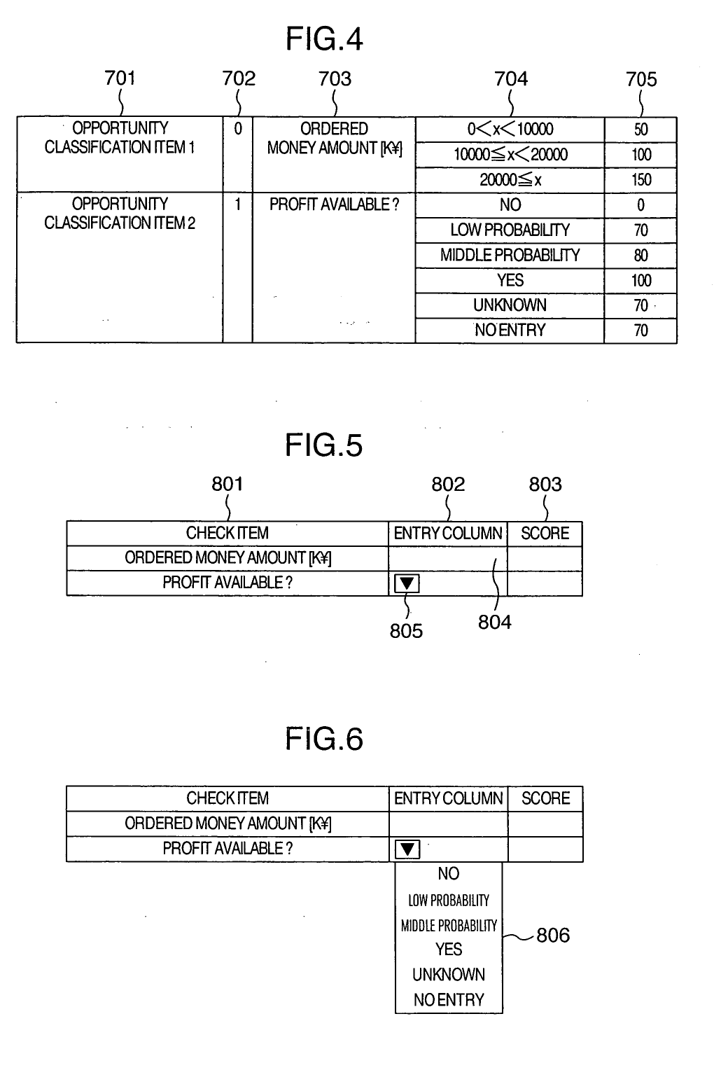

An example of data recorded in the opportunity check item database (7) is shown in FIG. 4. More specifically, items recorded include an index code (701) which uniquely recognize an opportunity check item; code information (702) which defines whether the opportunity check item is of a description input type (code:0) or of a selection input type (code: 1); text data (703) displayed as a question sentence for the opportunity check item; input information set data (704) which defines an input area format (money amount ‘input area’, etc.) for the description input type, contents of each choice for the selection input type, and an index for ‘yet-to-be-filled-out’ for use as the opportunity score ring rule; and definition data (705) of the opportunity score corresponding to each input information set data. The data is used as opportunity score ring data, as follows. For the input area format, if some information is input, then the value of definition data of the opportunity score is used as a score value. For the contents of the choice, if this choice is selected, then the value of definition data of the opportunity score corresponding to this choice is used as a score value. For no entry, if no entry, then the value of definition data of the corresponding opportunity score is used as a score value.

FIG. 5 shows an example of a display screen of an opportunity check list in the opportunity check list input device (8). In this display screen, a question sentence (801) for the opportunity check item, an entry column (802) for the opportunity check item, and an opportunity score display column (803) for each opportunity check item reflecting the input contents are displayed. For the entry column of the opportunity check item, information to be displayed varies with the input type of the opportunity check item. That is, for the description input type, the input format and an input area (804) are displayed. For the selection input type, a button (805) for displaying a list of choices for the opportunity check item is displayed.

FIG. 6 shows an example of a display screen when a mouth is clicked on the display button for a list of choices in the opportunity check list input device (8). A choice list (806) for the opportunity check item is displayed under the entry column for the opportunity check item clicked on the button, so that the user selects suitable one of a group of the displayed choices.

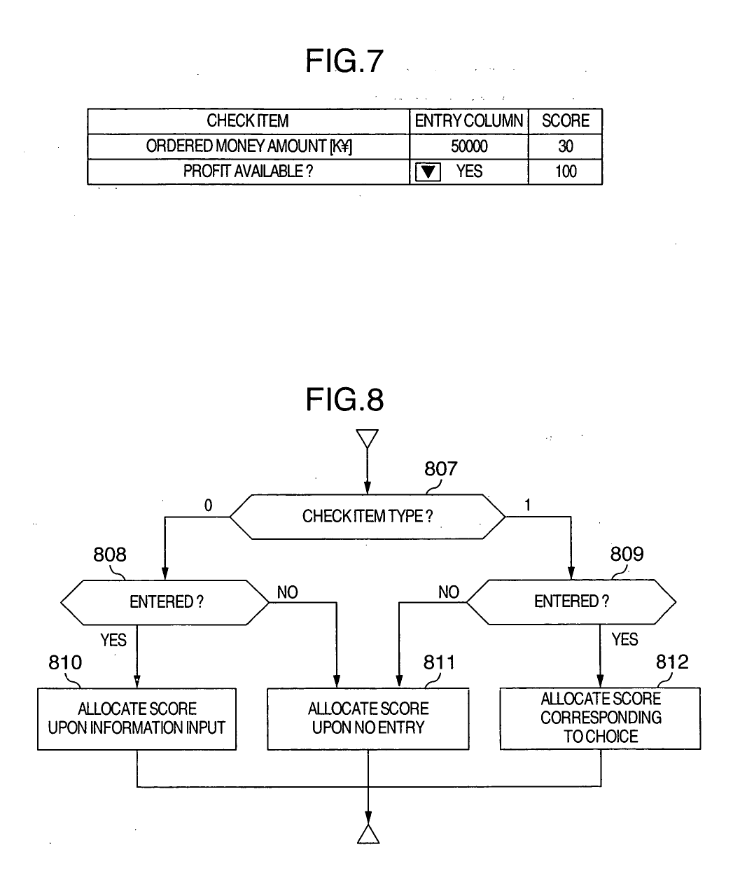

FIG. 7 shows an example of a display screen when user's entry and a opportunity score corresponding to the entry contents are displayed in the opportunity check list input device (8).

FIG. 8 shows a flow chart of operations of calculating an opportunity score in the opportunity check list input device (8). In a decision step (807), the system determines whether the input type for the opportunity check item is the description input type (code:0) or the selection input type (code:1). In the case of the description input type, the system proceeds to a decision step (808). In the case of the selection input type, the system proceeds to a decision step (809). In the decision step (808), the system determines whether or not information is entered in the input area of the description type. When information is entered, the system proceeds to a processing step (810). When no information is entered, the system proceeds to a processing step (811). In the decision step (809), the system determines whether or not some choice is selected. When a choice is input, the system proceeds to a processing step (812). When no information is input, the system proceeds to the processing step (811). In the processing step (810), the system sets the value of the opportunity score data upon the information entry as the value of the opportunity score for the opportunity check item. In the processing step (811), the system sets the value of the opportunity score data upon no entry of information as the value of the opportunity score for the opportunity check item. In the processing step (812), the system sets the value of opportunity score data corresponding to the entered choice as the value of the opportunity score for the opportunity check item.

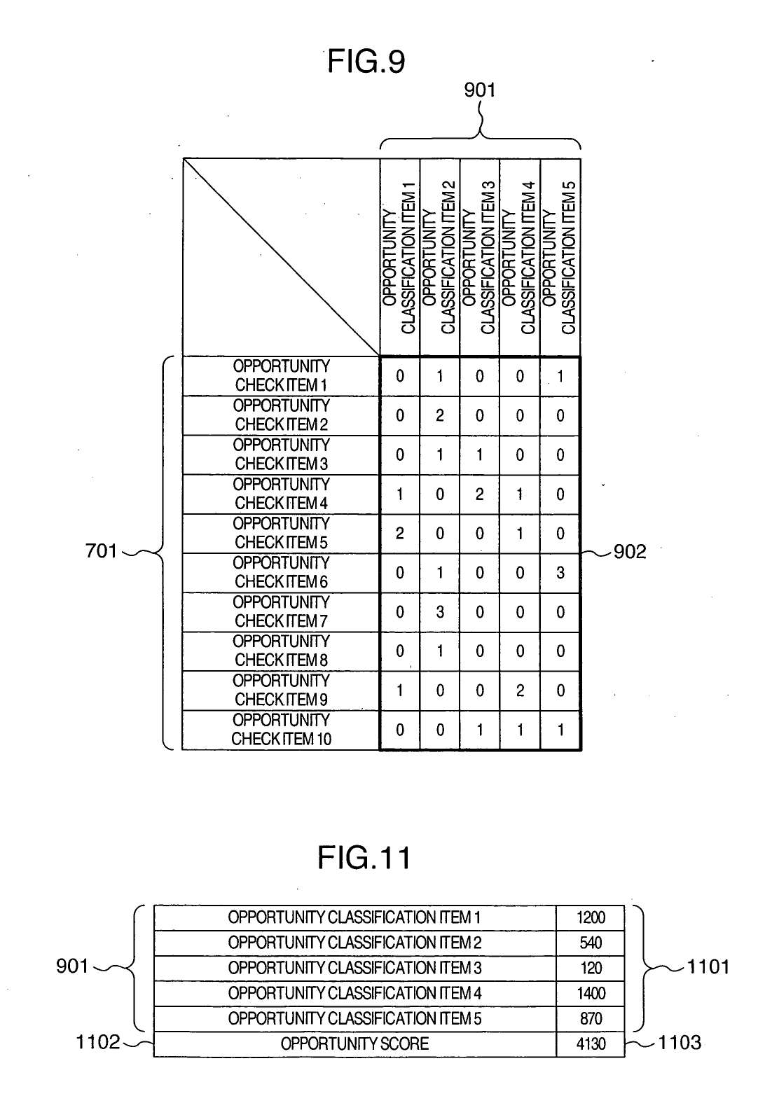

FIG. 9 shows an example of data recorded in the opportunity classification/check correspondence database (9). More specifically, items recorded include data (901) (title data for the opportunity classification item) for uniquely defining the opportunity classification item, an index code (701) for uniquely recognizing the opportunity check item, and data (902) for defining the degree of a correspondence between the opportunity classification item and the opportunity check item. The data (902) for defining the correspondence is defined as “0” when no correspondence is present and as a numeric value corresponding to the degree of the correspondence when the correspondence is present. In other words, the larger the data value is the stronger the correspondence is.

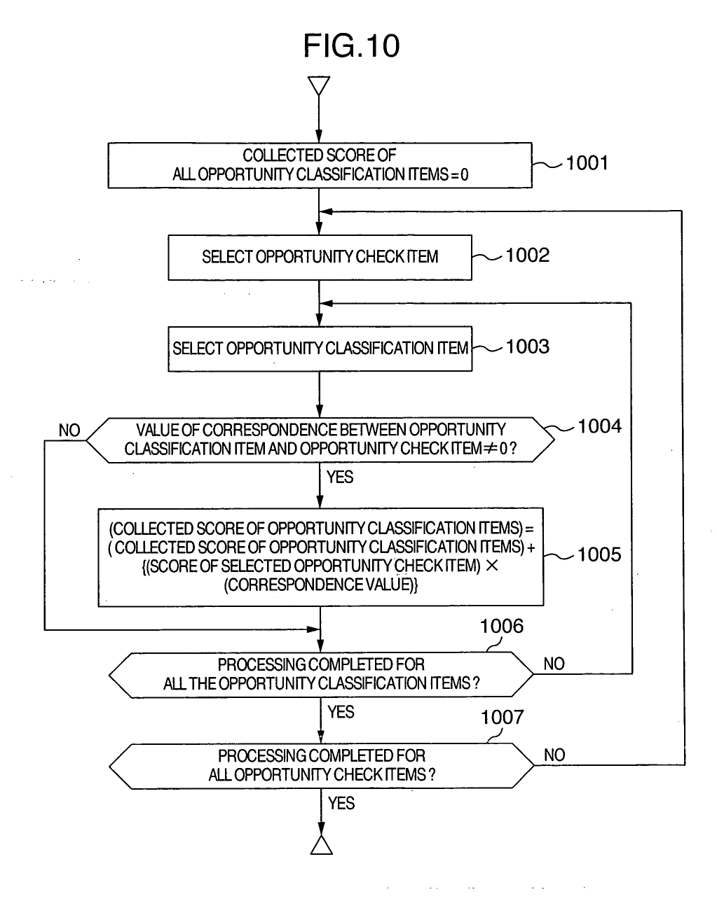

FIG. 10 shows a flow chart of operations in the opportunity score collecting device (10). In a processing step (1001), the system initializes the values of the collected scores of all the opportunity classification items to “0”. In a processing step (1002), the system selects one of the opportunity check items not selected yet in the processing flow. In a processing step (1003), the system selects one of the opportunity classification items not selected yet in this processing flow. In a decision step (1004), the system extracts data about a correspondence between the opportunity check item selected in the processing step (1002) and the opportunity classification item selected in the processing step (1003) from the opportunity classification/check correspondence data (9). When the extracted data has a value of “0”, the system proceeds to a decision step (1006), whereas, when the extracted data has a value other than “0”, the system proceeds to a processing step (1005). In the processing step (1005), the system updates the value of the collected scores of the opportunity classification item selected in the processing step (1003) in accordance with a computation expression (1) which follows.
(collected opportunity classification item score)=(collected opportunity classification item score)+{(selected opportunity check item score)×(correspondence value)} (1)

In the decision step (1006), the system determines whether or not processing was completed for all the opportunity classification items. When processing was completed for all the opportunity classification items, the system proceeds to a decision step (1007). In the presence of the opportunity classification item the processing of which is not completed yet, the system proceeds to the processing step (1003). In the decision step (1007), the system determines whether or not processing was completed for all the opportunity check items. When processing was completed for all the opportunity check items, the system terminates its operation. In the presence of the opportunity check item not completed yet, the system goes to the processing step (1002).

FIG. 11 shows an example of data recorded in the opportunity classification item score database (11). More specifically, items recorded include data (title data of the opportunity classification item) (901) for uniquely defining the opportunity classification item, a collected score (1101) for each opportunity classification item, an index (1102) indicative of a total value of the collected scores of all the opportunity classification items, and a total value (1103) of collected opportunity scores of all the opportunity classification items.

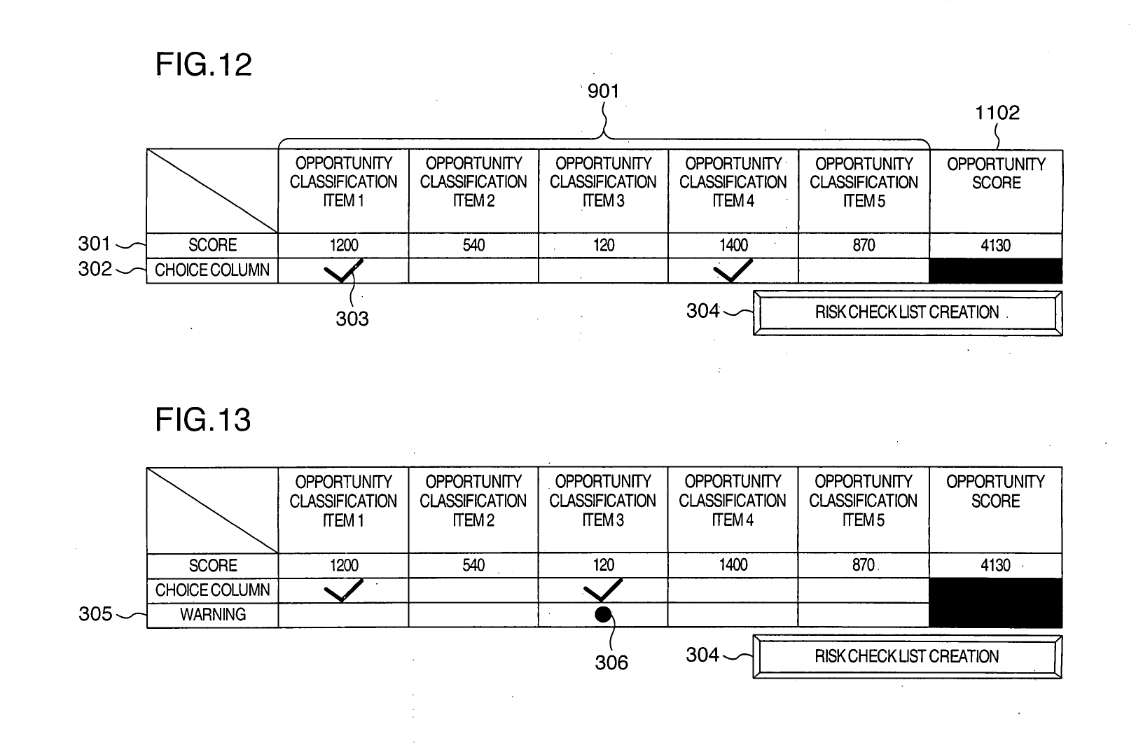

FIG. 12 shows an example of a display screen of the opportunity classification item selecting device (3). Displayed in this display screen are data (title data of the opportunity classification item) (901) for uniquely defining the opportunity classification item, an index (1102) indicative of a total value of the collected opportunity scores for all the opportunity classification items, each opportunity classification item, an opportunity score value (301) as the total value of the collected scores, a choice column (302) for selecting the opportunity classification item of the analysis target business, and a button (304) for creation of a risk check list. Selection of the opportunity classification items for the analysis target business is carried out by the user who designates the choice column (302) for the opportunity classification item to be desirably chosen. After the selection is carried out, a check mark (303) indicative of having selected is displayed. After selection of one or more opportunity classification items, clicking on the risk check list creation button (304) causes the system to proceed to the processing of the risk check item extracting device (4).

FIG. 13 shows an example of a display screen when a warning is displayed on the basis of information on the magnitude of the collected score value of the opportunity classification item and on the result of the opportunity classification item chosen by the user in the opportunity classification item selecting device (3). In this display screen, when the total value of collected scores of the items selected by the user as the opportunity classification item is not larger than a constant reference value, a warning indicator (306) is displayed in a warning display column (305).

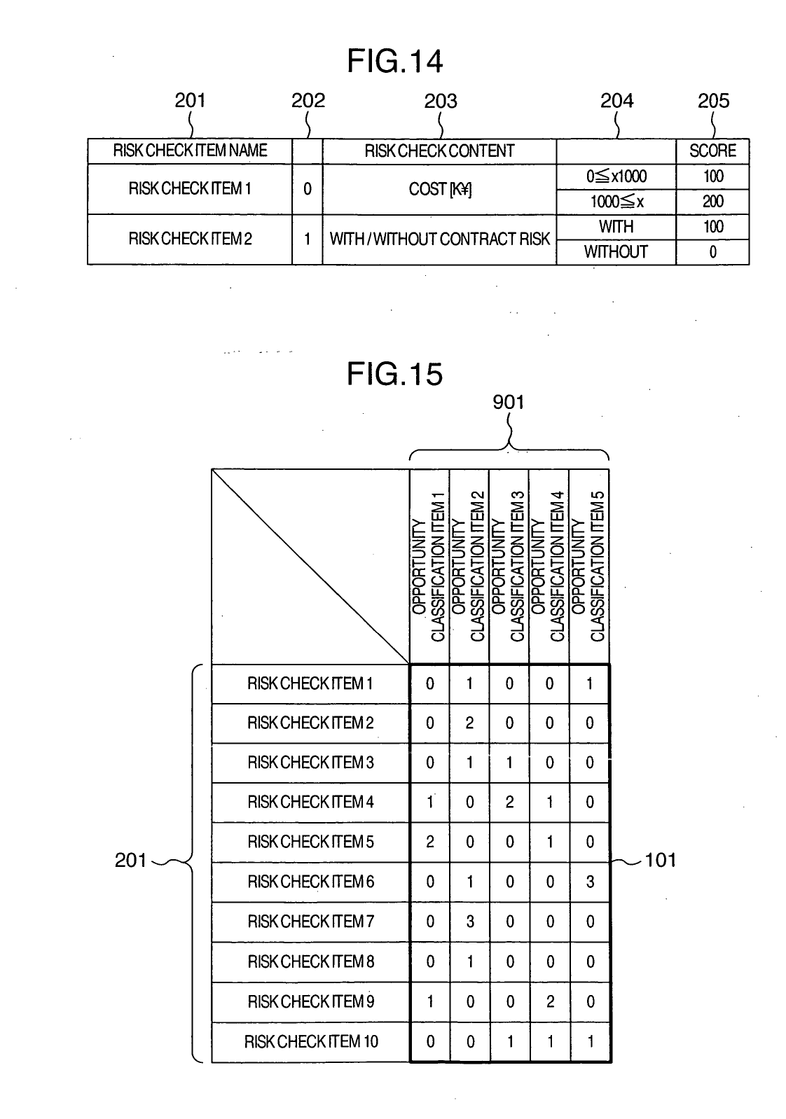

An example of data recorded in the risk check item database (2) is shown in FIG. 14. More specifically, items recorded include an index code (201) for uniquely recognizing the risk check item; code information (202) for defining whether the risk check item is of the description input type (code:0) or of the selection input type (code:1); text data (203) displayed as a question sentence for the risk check item; input information set data (204) for defining an input area format (money amount ‘input area’, etc.) for the description input type, the contents of each choice for the selection input type, and an index of ‘no entry’ for use as a risk score ring rule; and definition data (205) the risk score corresponding to each input information set data. This data is used as risk score ring data, as follows. That is, for the input area format, if some information is input, then the value of definition data of the risk score is used as a score value. For the choice contents, if this choice is selected, then the value of definition data of the risk score corresponding to the choice is used as a score value. For no entry, the value of definition data of the corresponding risk score is used as a score value.

FIG. 15 shows an example of data recorded in the opportunity/risk item correspondence database (1). More specifically, items recorded include data (title data of the opportunity classification item) (901) for uniquely defining the opportunity classification item, an index code (201) for uniquely recognizing the risk check item, and data (101) for defining the magnitude of a correspondence between the opportunity classification item and the risk check item. With respect to the data (101) for defining the correspondence, when no correspondence is present, the data is defined as “0”. In the presence of the correspondence, the data is defined as a numeric value corresponding to the magnitude of the correspondence. In other words, the larger the data value is the stronger the correspondence is.

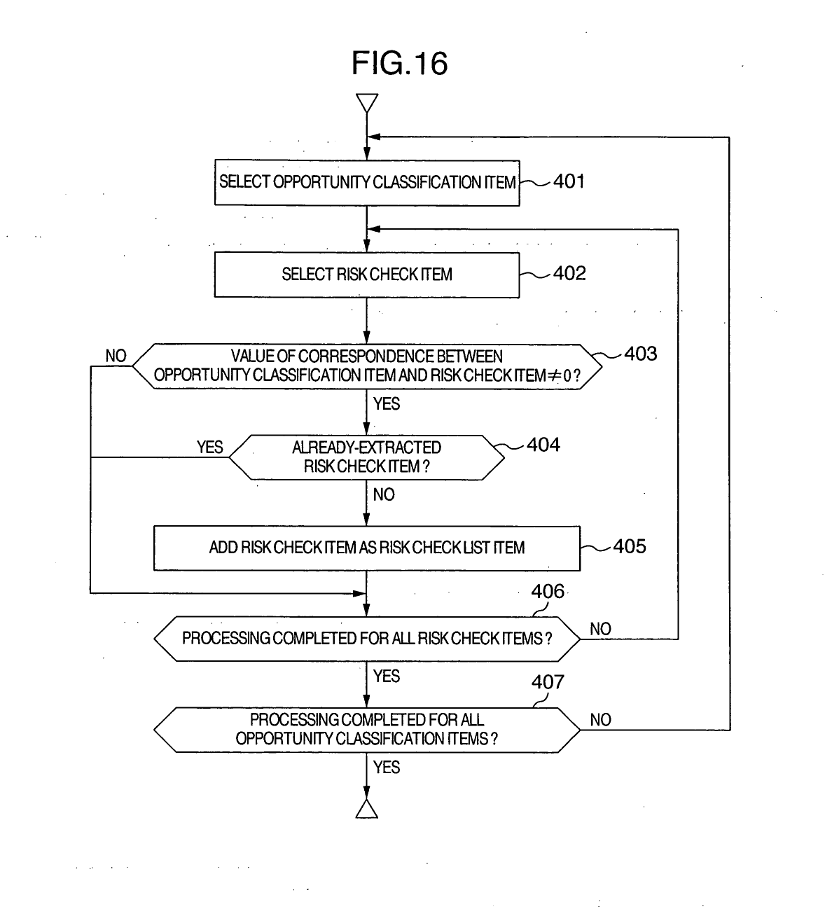

FIG. 16 shows a flow chart of operations in the risk check item extracting device (4). In a processing step (401), the system selects one of the opportunity classification items not selected yet in this processing flow. In a processing step (402), the system selects one of the risk check items not selected yet in this processing flow. In a decision step (403), the system extracts data about a correspondence between the opportunity classification item selected in the processing step (401) and the risk check item selected in the processing step (402) from the opportunity/risk item correspondence database (1). When the extracted data has a value of “0”, the system proceeds to a decision step (406). When the extracted data has a value other than “0”, the system proceeds to a decision step (404). In the decision step (404), the system determines whether or not the risk check item selected in the processing step (402) is the risk check item already extracted in this processing flow. In the case of the already-extracted risk check item, the system proceeds to the decision step (406). In the case of the risk check item not extracted yet, the system proceeds to a processing step (405). In the processing step (405), the system adds the risk check item selected in the processing step (402) as a risk check item in the risk check list of the analysis target business. In the decision step (406), the system determines whether or not processing was completed for all the risk check items. When processing is already completed for all the risk check items, the system proceeds to a decision step (407). In the presence of a risk check item not subjected yet to processing, the system goes to the processing step (402). In the decision step (407), the system determines whether or not processing is already completed for all the opportunity classification items. When processing is already completed for all the opportunity classification items, the system terminates its operation. In the presence of an opportunity classification item not processed yet, the system goes to the processing step (401).

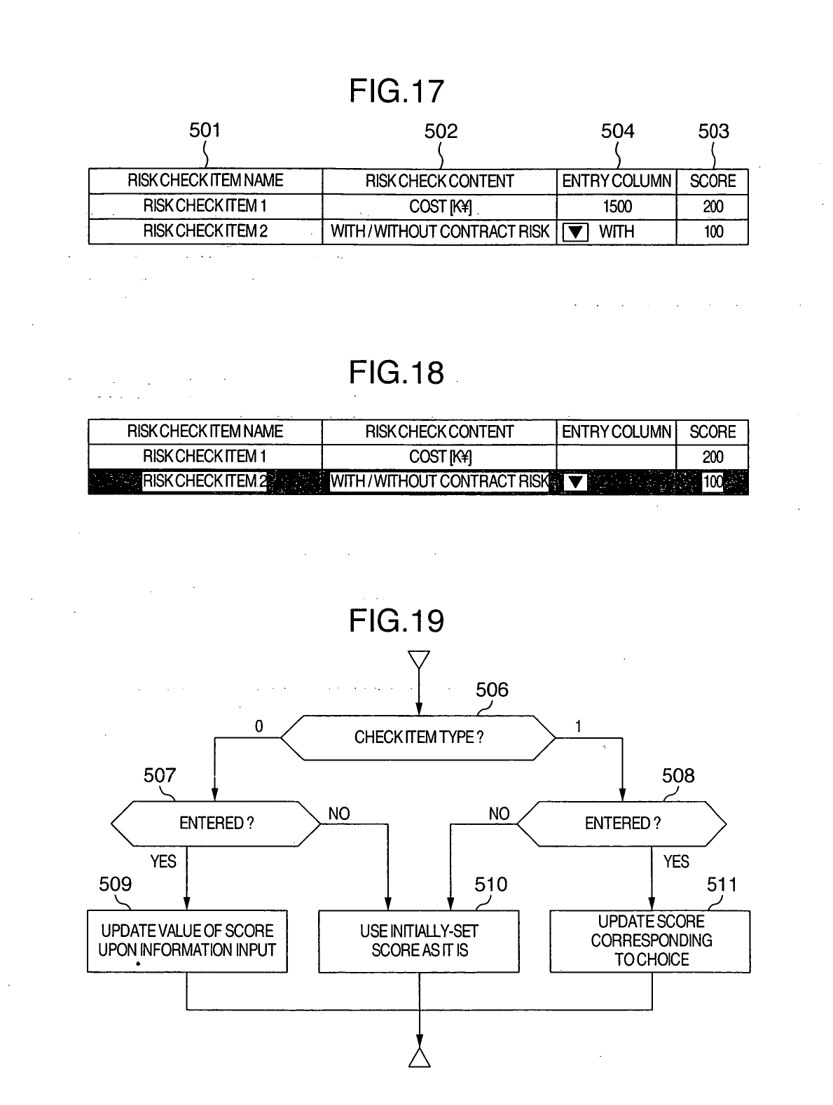

FIG. 17 shows an example of a display screen of a risk check list in the risk check list input device (5). Displayed in this display screen are a question sentence (501) for a risk check item, an entry column (502) for the risk check item, and a risk score display column (503) for each risk check item reflecting the entry contents. Display information in the entry column of the risk check item varies with the input type of the risk check item. For the description type, the input format and an input area (504) are displayed. For the selection type, a button (505) for displaying a list of choices for the risk check item is displayed. In the risk check list, the value of a risk score upon no entry of information is previously set in the risk score display column (503) as an initial value.

FIG. 18 shows an example of a display screen when the display area of the question sentence (501) for each risk check item in the display screen of the risk check list is highlighted according to the magnitude of value of a correspondence between each risk check item and the opportunity classification item selected by the user, derived upon the operation of the risk check item extracting device (4) in the risk check list input device (5). The larger the value of the correspondence is the deeper the displayed color is. In this connection, when one risk check item has a correspondence with a plurality of the opportunity classification items selected by the user, processing is carried out with use of a summed value of values of correspondences with the respective opportunity classification items.

FIG. 19 shows a flow chart of operations of calculating a risk score in the risk check list input device (5). In a decision step (506), the system determines the input type of the risk check item is of the description type (code:0) or of the selection type (code:1). For the description type, the system proceeds to a decision step (507). For the selection type, the system proceeds to a decision step (508). In the decision step (507), the system determines whether or not information is entered in the input area of the description type. When information is entered, the system proceeds to a processing step (509). When no information is entered, the system proceeds to a processing step (510). In the decision step (508), the system determines whether or not some choice is selected. When a choice is input, the system proceeds to a processing step (511). When no information input, the system proceeds to the processing step (510). In the processing step (509), the system sets the value of the risk score data upon the information input as the value of a risk score of the risk check item. In the processing step (510), the system uses the value of the risk score data as an initial value, as it is, upon no information input previously set. In the processing step (511), the system sets the value of the risk score data corresponding to the input choice as the value of the risk score of the risk check item.

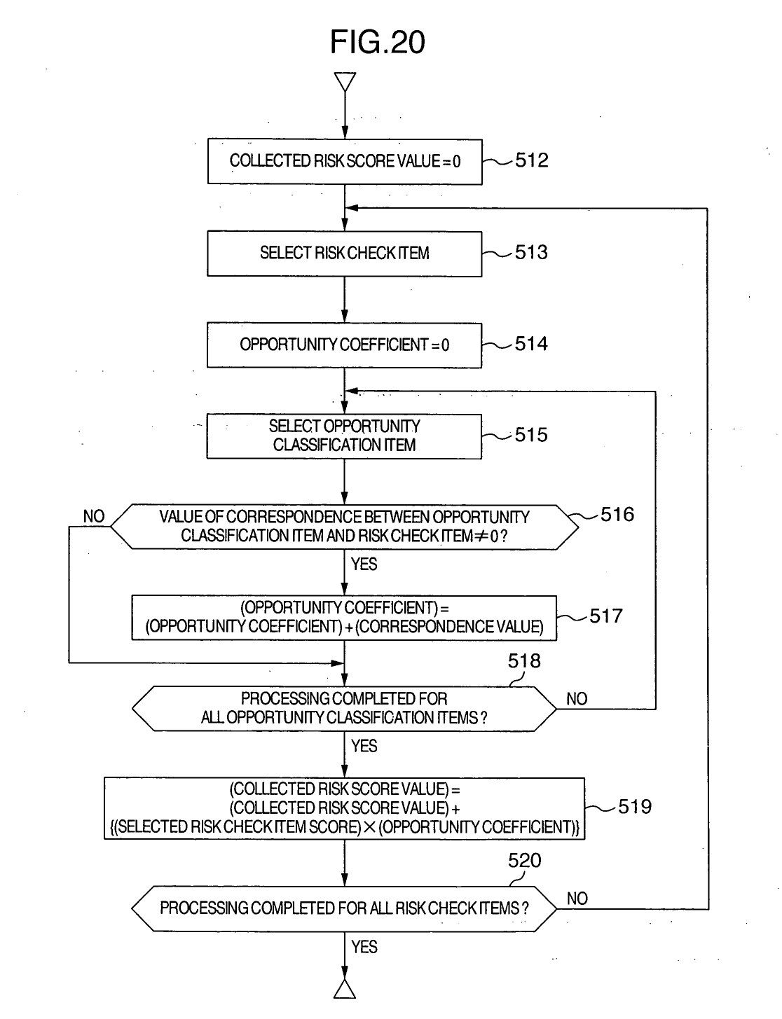

FIG. 20 shows a flow chart of operations of collecting risk scores in the risk check list input device (5). In a processing step (512), the system initializes a total value of the collected values of the risk scores to “0”. In a processing step (513), the system selects one of the risk check items not selected yet in this processing flow. In a processing step (514), the system initializes the value of an opportunity coefficient to “0”. In a processing step (515), the system selects one of the opportunity classification items not selected yet in this processing flow. In a decision step (516), the system extracts data about a correspondence between the risk check item selected in the processing step (513) and the opportunity classification item selected in the processing step (515) from the opportunity/risk item correspondence database (1). When the extracted value is “0”, the system proceeds to a decision step (518). When the extracted value is other than “0”, the system proceeds to a processing step (517). In the processing step (517), the system updates the value of the opportunity coefficient in accordance with a computation expression (2) which follows.
(opportunity coefficient)=(opportunity coefficient)+(correspondence value) (2)

In the decision step (518), the system determines whether or not processing is already completed for all the opportunity classification items. When processing is already completed for all the opportunity classification items, the system proceeds to a processing step (519). In the presence of an opportunity classification item not processed yet, the system proceeds to the processing step (515). In the processing step (519), the system updates a total value of collected values of the risk scores in accordance with a computation expression (3) which follows.
(collected risk score value)=(collected risk score value)+{(score of selected risk check item)×(opportunity coefficient)} (3)

In a decision step (520), the system determines whether or not processing is already completed for all the risk check items. When processing is already completed for all the risk check items, the system terminates its operation. In the presence of a risk check item not processed yet, the system proceeds to the processing step (513).

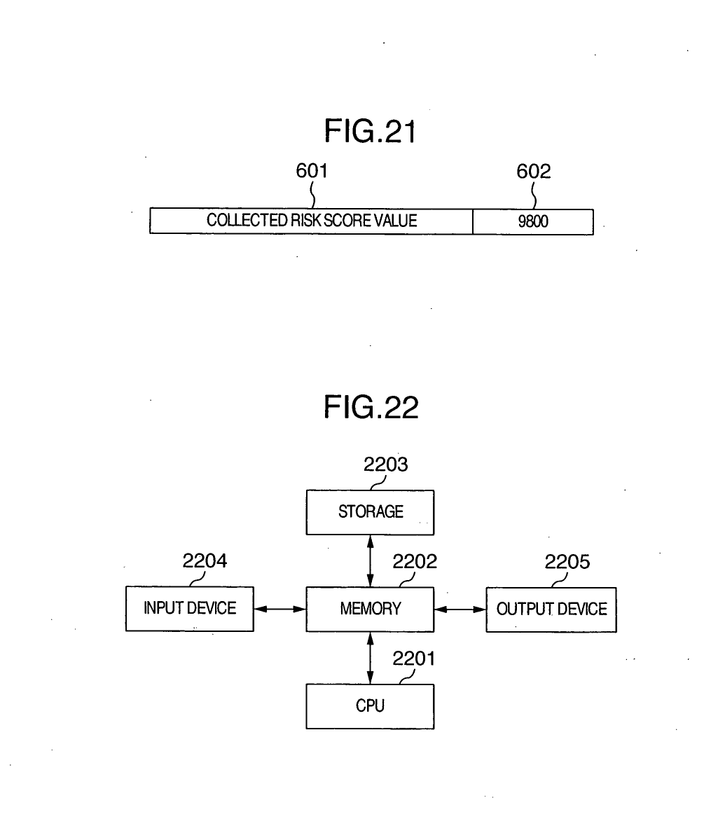

FIG. 21 shows an example of data recorded in the risk score database (6). More specifically, items recorded include an index (601) for the collected risk score value, and a value (602) for the index of the collected risk score value.

An example of operations in the present invention has been explained. When such operations are actually implemented with use of a system, the system includes, as hardware, a CPU (2201), a memory (2202), a storage (2203), an input device (2204), and an output device (2205) as shown in FIG. 22. The system is arranged so that a program and a database in the present invention recorded in the storage (2203) is transmitted to the memory (2202), the CPU (2201) processes them on the basis of instruction information received from the input device (2204) to display its processed result on the output device (2205).

It should be further understood by those skilled in the art that although the foregoing description has been made on embodiments of the invention, the invention is not limited thereto and various changes and modifications may be made without departing from the spirit of the invention and the scope of the appended claims.

1. A business justification analysis system for evaluating a business comprising:
a database for storing information for defining a correspondence between opportunity classification items of the business and risk check items of the business;
input means for selecting the opportunity classification items of a business to be analyzed;
extraction means for extracting the risk check items of the business corresponding to the opportunity classification items selected by said input means on the basis of the correspondence between the opportunity classification items of the business and the risk check items of the business, said correspondence being defined in said database; and
risk check list creation means for creating a risk check list of the risk check items extracted by said extraction means.

2. A business justification analysis system according to claim 1, wherein said database includes a database for storing information about the magnitude of the correspondence as the information for defining the correspondence between the opportunity classification items of the business and the risk check items thereof and also includes means for summing scores of the risk check items on the basis of the information about the magnitude of the correspondence stored in said database.

3. A business justification analysis system according to claim 1, wherein said database includes a database for storing information about the magnitude of the correspondence as the information for defining the correspondence between the opportunity classification items of the business and the risk check items thereof and also includes display means for changing a display color of each of the risk check items in the risk check list created by said risk check list creation means according to said information and displaying the risk check list.

4. A business justification analysis system for evaluating a business comprising:
a database for storing information for defining a correspondence between opportunity check items of the business for checking an opportunity of the business and opportunity classification items of the business;
input means for a user to entering an input for the opportunity check items;
calculation means for computing scores of the opportunity check items according to contents entered by the user from said input means.

5. A business justification analysis system according to claim 4, wherein said database stores information about the magnitude of the correspondence as information for defining the correspondence between the opportunity classification items of the business and the risk check list items thereof, and said calculation means includes means for summing scores of the opportunity check items on the basis of the information about the magnitude of the correspondence stored in said database.

6. A business justification analysis system according to claim 4, wherein, when the score of the opportunity classification item selected by the user is not larger than a constant reference value, said system displays a warning.

7. A business justification analysis system according to claim 4, wherein the information for defining the correspondence between the opportunity classification items of the business and the risk check list items has information indicative of the magnitude of the correspondence, and when the scores of the risk check items are summed, different weights are applied to the check items according to said information.

8. A business justification analysis system according to claim 4, wherein the information for defining the correspondence between the opportunity classification items of the business and the risk check list items has information indicative of the magnitude of the correspondence, and a display color of each of the check items in the risk check list is changed according to said information.

9. A business justification analysis program capable of being read into a system having a computer and a database under control of said computer, wherein said computer functions as a database for defining a correspondence between opportunity classification items of a business and risk check items of the business, input means for selecting the opportunity classification items of a business to be analyzed extraction means for extracting the risk check items corresponding to the opportunity classification items selected by said input means on the basis of the correspondence between the opportunity classification items of the business and the risk check items of the business defined by said database, and risk check list creation means for creating a list of the risk check items extracted by said extraction means.

10. A business justification analysis program according to claim 9, wherein the information for defining the correspondence between the opportunity classification items of the business and the risk check list items has information about the magnitude of the correspondence, and said computer further functions as means, when scores of the risk check items are summed, for applying different weights to the respective check items according to said information.
